(19) United States
(12) Patent Application Publication
(10) Pub. No.: US 2005/0050442 A1
(43) Pub. Date: Mar. 3, 2005

(54) System and method of publication

(76) Inventors: Carter Pope, Atlanta, GA (US); Kenneth R. Adams, Roswell, GA (US); Douglas C. Fergusson, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/909,574

(22) Filed: Aug. 2, 2004

Related U.S. Application Data
(60) Provisional application No. 60/499,246, filed on Aug. 29, 2003.

(51) Int. Cl. G06F 17/00

(52) U.S. Cl. 715/500

(57) ABSTRACT

A software-implemented system and method of publication for preparing or publishing a customized document that provides information specifically pertinent or relevant to a customer's product and/or service order, demands, contractual obligations, and the like (i.e., a customer's business rules), wherein such information is selected from a template of variable data or an information content database, and removed or formatted based upon an evaluation of the customer's business rules and transactional request for information, thereby yielding a compact, concise and personalized document devoid of any extraneous, inapplicable, and/or other trivial information.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### PRIORITY CLAIM AND CROSS-REFERENCE TO RELATED APPLICATIONS

To the fullest extent permitted by law, the present nonprovisional patent application claims priority to and the full benefit of provisional patent application entitled “SYSTEM AND METHOD OF PUBLICATION”, filed on Aug. 29, 2003, and having assigned Ser. No. 60/499,246.

### TECHNICAL FIELD

The present invention relates generally to methods of publication, and more specifically to a software-implemented system and method of publication for preparing or publishing a customized document that provides information specifically pertinent or relevant to a customer's product and/or service order, demands, contractual obligations, and the like (i.e., a customer's business rules), wherein such information is selected from a template of variable data or an information content database, and removed or formatted based upon an evaluation of the customer's business rules and transactional request for information, thereby yielding a compact, concise and personalized document devoid of any extraneous, inapplicable, and/or other trivial information.

### BACKGROUND OF THE INVENTION

Purchased product and/or service orders are typically accompanied by informational booklets, pamphlets and related documents that provide the purchasing consumer with information directed to product/service details and specifics, consumer/company contractual duties, product operations manuals and instructions, product/service warranties, company information, and the like. However, in an effort to efficiently and expeditiously provide consumers with purchased product or service orders, many companies typically package the product, or supply consumers, with general product/service informational booklets and documents that are typically directed to a wide variety of product/service lines, and usually provide the consumer with extraneous or inapplicable information, thereby forcing the consumer to search through an excessive amount of information in order to extract information relevant to the consumer's purchased product/service. Unfortunately, because such general informational publications contain product/service lines that differ only marginally in detail and specifics, consumers are often confused as to what product/service they have purchased, and as to what the product/service offers.

Although packaging the product, or supplying the consumers, with such general product/service informational booklets may expedite a company's product/service publications process, the benefits experienced thereby are greatly outweighed by the vast amount of time and money expended by the company's customer assistance service center. More specifically, such customer assistance service centers are often overwhelmingly occupied with managing and resolving customer confusion associated with purchased product/service lines, orders, contractual duties, product operations, and warranties - specifics and details that would seemingly be addressed in the general informational booklets. Additionally, consumer confusion may also result in consumer dissatisfaction with, and potential accidental destruction of, the product, and therefore the subsequent return of same, thereby costing the company additional time and money in customer pacification, product replacement, product restocking, updating the consumer database, refunding the purchase price, product repair, product refurbishment, product resale, and/or the like.

Furthermore, although expeditious, publication of general informational booklets imparts a large financial cost unto companies, as the cost of high quality printing paper and multi-colored inks is greatly increased in view of the typical and relatively voluminous nature of general informational booklets.

Moreover, because a plurality of such booklets, pamphlets and inserts are usually combined and packaged with the product, or supplied to the customer, by a staff of employees in an assembly-line manner, or other multi-employee labor-intensive method, the cost of overhead associated with such publication and supply processes is significantly increased. Additionally, manual-based publication packaging and fulfillment processes are subject to inherent human error, and, as such, significantly lend to the inaccuracies and inconsistencies in informational publication, supply, and fulfillment processes.

As such, the above-discussed traditional means of publication and fulfillment processes is limited in the level of individualization of content and consumer customization, as the number of permutations of generic brochures, forms, pamphlets and booklets utilized to assemble “kits” of information is accordingly limited.

Although commercially available software products might enable selected informational content to be dynamically combined from information stored in a database to yield a defined parameter of information, such software systems do not fully integrate consumer transaction control and feedback into the process. That is, consumer transaction control is key to ensuring that all consumer transaction requests for information (i.e., product/service information, contractual obligations, warranties, or otherwise) are produced accurately, consistently, and provided expeditiously to the customer without extraneous or inapplicable information, so as to avoid the above-discussed consumer confusion, dissatisfaction and associated company operational costs and problems.

Therefore, it is readily apparent that there is a need for a software-implemented system and method of publication for preparing or publishing a customized document that provides information specifically pertinent or relevant to a customer's product and/or service order, demands, contractual obligations, and the like (i.e., a customer's business rules), wherein such information is selected from a template of variable data or an information content database, and removed or formatted based upon an evaluation of the customer's business rules and transactional request for information, thereby yielding a compact, concise and personalized document devoid of any extraneous, inapplicable, and/or other trivial information. There is also a need for such a system and method that fully integrates consumer transaction control and feedback for accurate, consistent, and expeditious production of consumer transaction requests for information, thereby avoiding significant financial costs typically associated with prior art methods of informational document assembly and fulfillment request processes.

### BRIEF SUMMARY OF THE INVENTION

Briefly described, in a preferred embodiment, the present invention overcomes the above-mentioned disadvantages and meets the recognized need for such an invention by providing a software-driven system and method of publication that combines informational content into a single, individualized or personalized document based upon a transaction database and a set of business rules particular to a selected customer and the customer's transactional request for information, wherein such informational content is selected from a template of variable data or an information content database, and removed or formatted based upon an evaluation of the customer's business rules and transactional request for information, thereby yielding a compact, concise and personalized document devoid of any extraneous, inapplicable, and/or other trivial information. The customized publications may accompany customer purchased products/services, and include information specifically directed to product/service details and specifics, consumer/company contractual duties, product operations manuals and instructions, product/service warranties, company information, and the like.

According to its major aspects and broadly stated, the present invention in its preferred form is a system and method of publication utilized to create and deliver a single, custom printed document to an individual to fulfill a request for information.

More specifically, the present invention is a system and method of publication utilizing software to effectuate the electronic combination of informational content into a single, customized document via selection of the informational content from a database of variable information, and evaluating same against a set of customer business rules. The method is preferably supported via a system of software, databases, and computer and printer hardware, wherein the system is preferably organized into a series of sub-systems that include a transaction insertion agent, transaction database, transaction scanning agent, business rules engine, content database, dynamic document generator and assembler, and demand print engine.

The process is preferably initiated with order transaction data that typically includes a customer's or individual's name, address, and data that can be utilized to extract or derive the specific information and content that needs to be assembled into the customized published document. The transaction data is preferably electronically delivered into the process and inserted into the transaction database by the transaction insertion agent. All transactions are preferably validated against a set of specifications prior to insertion into the database, wherein any transactions that contain erroneous or invalid data are routed into an error transaction file. Only valid transactions are inserted into the transaction database, wherein the error transaction file is set aside for subsequent exception handling.

The transaction scanning agent preferably continuously monitors the transaction database for new transactions or changes to the status of transactions. The transaction scanning agent preferably operates by systematically processing transactions based upon a set of business rules derived from the customer's transactional request for information. Preferably, the business rules include the prioritization of workflow, where the dynamic documents are to be printed, and other rules designed to ensure that the dynamic documents are generated correctly and delivered on time to the customer. The transaction scanning agent then dispatches transactions to the business rules engine for subsequent processing by same. The transaction scanning agent also preferably monitors transaction workflow throughout the process and communicates business alerts whenever a transaction falls outside of a specific set of control parameters.

Preferably, the business rules engine governs the process of extracting data and library documents from the content database. The business rules engine ensures that the right content is matched to the transaction. The business rules engine sets aside for error handling any transactions for which a complete set of content cannot be assembled. Once the business rules engine assembles a complete set of content for a transaction, the data set is passed to the dynamic document generator and assembler.

Preferably, the dynamic document generator and assembler combines all of the data and content supplied by the business rules engine into a consolidated document optimized for electronic delivery (PDF, etc.) or printing (PDF, Postscript, etc.) by the demand print engine. Preferably, the consolidated document is devoid of any extraneous, inapplicable, and/or other trivial information not originally requested by the customer or defined by the business rules, thereby providing a customized document.

The demand print engine preferably manages the workflow of documents to commercially available digital print engines. That is, the demand print engine groups documents into logical lots for production control, and provides feedback to the transaction database.

Finally, all customized documents are preferably scanned prior to delivery to a common carrier (USPS, UPS, FEDEX, AIRBORNE, DHL, etc.) so that the transaction database can be updated to reflect delivery confirmation and/or completion of orders. Additionally, when available, scanned shipping/delivery data provided by the common carriers is inserted into the transaction database to monitor the shipment and delivery of each transaction to its final destination.

The recipient of the completed document(s) enjoys the benefits of fast and reliable fulfillment of their request, and of a highly personalized package of information tailored to his/her needs.

Accordingly, a feature and advantage of the present invention is its ability to provide a software-implemented system and method of publication.

Another feature and advantage of the present invention is its ability to provide a customized document that provides information specifically pertinent or relevant to a customer's product and/or service order, demands, contractual obligations, and the like (i.e., a customer's business rules).

Still another feature and advantage of the present invention is its ability to provide a customized document by extracting desired information from a database of variable data based upon an evaluation of a customer's business rules or transactional request.

Yet another feature and advantage of the present invention is its ability to provide a compact, concise and personalized document devoid of any extraneous, inapplicable, and/or other trivial information.

Yet still another feature and advantage of the present invention is its ability to fully integrate customer transaction control and feedback for accurate, consistent, and expeditious production of consumer transaction requests for information, thereby avoiding significant financial costs typically associated with prior art methods of informational document assembly and fulfillment request processes.

A further feature and advantage of the present invention is its ability to reduce or eliminate inaccuracies, human-error, and overall cost associated with conventional publishing and fulfillment processes.

Still a further feature and advantage of the present invention is its ability to reduce the amount of manual-based or multi-employee based, labor-intensive, methods of publication and fulfillment processes.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a flow diagram of a system and method of publication according to a preferred embodiment of the present invention;

FIG. 2 is a flow diagram of a system and method of publication according to a preferred embodiment of the present invention;

FIG. 3 is a flow diagram of a system and method of publication according to a preferred embodiment of the present invention, exemplifying application of same to a wireless telecommunications transaction; and,

FIG. 4 is a diagram of a transaction database of a system and method of publication according to a preferred embodiment of the present invention, exemplifying application of same to a wireless telecommunications transaction;

### DETAILED DESCRIPTION OF THE PREFERRED AND ALTERNATIVE EMBODIMENTS

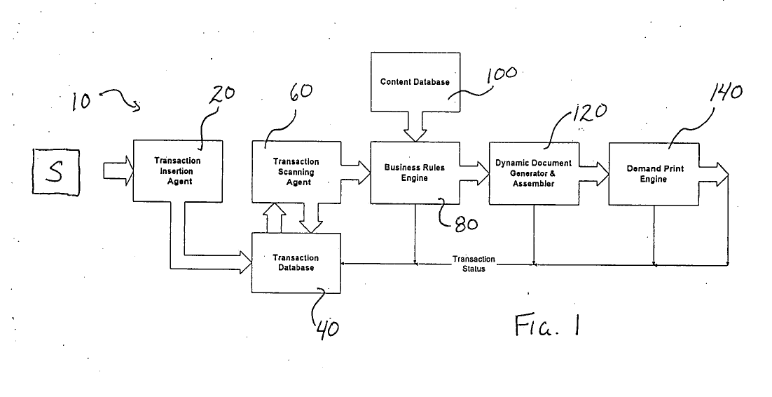

In describing the preferred and representative alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

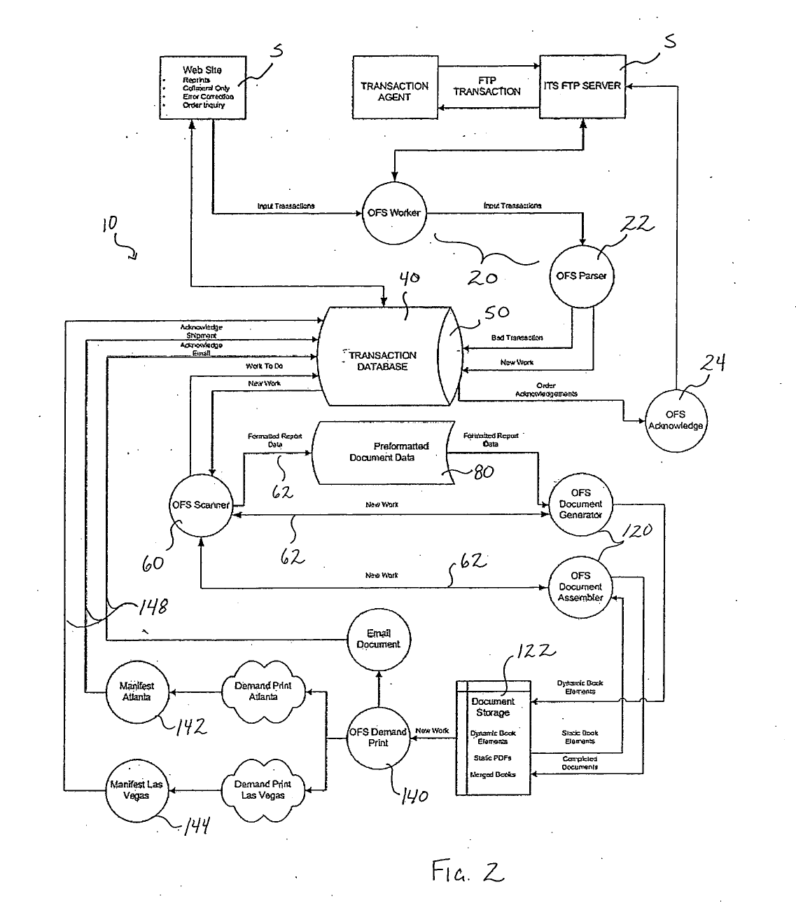

Referring now to FIGS. 1-2, the present invention in a preferred embodiment is a system and method of publication 10, wherein system 10 is preferably supported via a configuration of software and organized into a series of sub-systems that include a transaction insertion agent 20, transaction database 40, transaction scanning agent 60, business rules engine 80, content database 100, dynamic document generator and assembler 120, and demand print engine 140.

Preferably, system and method 10 is provided by or made available through a publishing company, or other demand print service, to a customer (i.e., cellular phone company, internet service provider, product manufacturers, and the like) seeking to advertise and/or provide specific information on its products and/or services to a targeted consumer group (i.e., individual consumers, retailers, distributors, and the like). System and method 10 is preferably initiated upon the receipt of transaction data by transaction insertion agent 20 from a combination of sources S, preferably in the form of batch data files, as made available through file transfer protocol (FTP) servers associated with a company's product/service order call centers, and/or web-enabled interactive ordering systems, as delivered by hypertext transmission protocol secure (HTTPS) via conventional web browsers of a global networking system. Transaction data preferably includes a customer's or individual's name, delivery address (i.e., physical address and/or qualified electronic mailing address), and data that can be utilized to extract or derive the specific information and content that needs to be assembled to yield the customized published document, wherein such data preferably includes consumer demographics, and order detail information such as the type of products/services purchased, product/service details and specifics, consumer/company contractual duties and obligations, product operations manuals and instructions, product/service warranties, company contact information, and the like.

Following receipt of transaction data, transaction insertion agent 20 preferably performs analysis and error-checking functions on the transaction data. Specifically, parser 22 preferably parses or divides the transaction data into functional data components for validating same against a set of specifications or parameters that define accurate, complete and error-free data entries. Such error-checking functions and validation is preferably performed prior to inserting the transactional data into transaction database 40; that is, prior to populating transaction database 40 with the error-free transaction data. Transaction data having erroneous or invalid data is preferably routed into an error transaction file 50 and subsequently returned to sources S for correction and resubmission of same. Preferably, only valid, error-free transaction data is inserted into transaction database 40, wherein error transaction file 50 is set aside for subsequent exception handling. Transaction insertion agent 20 further logs and reports any data errors identified during the analysis and error-checking of the transaction data. Additionally, all orders or submissions of transaction data are preferably confirmed or acknowledged 24 by transmitting confirmation of receipt of same to sources S via FTP servers, electronic-mail, or the like.

Transaction database 40 preferably contains all of the error-free transaction data inserted therein by transaction insertion agent 20, and all of the transaction status information collected by transaction scanning agent 60. As more fully described below, the transaction data, in addition to a set of customer business rules, is preferably utilized to accurately select and extract relevant information from a variable database of information, wherein the relevant information is preferably incorporated into the final printed/published document.

Transaction scanning agent 60 continuously monitors transaction database 40 for the status of all transactions or changes to the status of transactions. Preferably, new transactions are dispatched 62 to the appropriate process downstream (i.e., business rules engine 80 and/or dynamic document generator and assembler 120, as more fully described below). Transaction status reports are automatically issued to transaction scanning agent 60 by the sub-systems listed above, thereby enabling transaction scanning agent 60 to constantly monitor the status of new, pending and old transaction requests. Specifically, the status reports are either triggered automatically by the completion of a computational process on a transaction, or by the scanning of bar-coded workflow control documents throughout the entire system and method 10. Transaction scanning agent 60 preferably ensures that all transactions progress through system and method 10 on schedule.

Transaction scanning agent 60 preferably operates by systematically processing transactions based upon a set of business rules derived from the customer's transactional request for information (i.e., the originally submitted transactional data). Preferably, the business rules include the prioritization of workflow, where the dynamic documents are to be printed, instructions for formatting informational content of the document, and other rules designed to ensure that the dynamic documents are generated correctly and delivered on time to the customer, as more fully described below. Transaction scanning agent 60 preferably dispatches transactions to business rules engine 80 for subsequent processing by same, as more fully described below. Additionally, transaction scanning agent 60 also preferably monitors transaction workflow throughout system 10, and communicates business alerts whenever a transaction falls outside of a specific set of control parameters defined by the business rules.

Preferably, business rules engine 80 extracts transaction data from transaction database 40 based upon instructions transmitted from transaction scanning agent 60. Thereafter, business rules engine 80 processes the transaction data based upon an application-specific set of business rules that govern the selective retrieval of stored data and content from content database 100, wherein content database 100 comprises a variety of look-up data and library document content (i.e., ranging from general or non-specific to specific information) utilized to create the specific and individualized dynamic document.

More specifically, business rules engine 80 governs the process of selectively extracting data and library documents from content database 100, wherein business rules engine 80 ensures that the correct content/information is formatted to match the transaction data specifics and business rules. Business rules engine 80 preferably sets aside for error handling any transactions for which a complete set of content cannot be assembled. Once business rules engine 80 assembles a complete set of content for a transaction, the data set is preferably passed to dynamic document generator and assembler 120 for appropriate assembly of the document.

Dynamic document generator and assembler 120 preferably combines the selected transaction data, look-up data, and library document content supplied by business rules engine 80 into a consolidated document optimized for electronic delivery (portable document format (PDF), or the like) or printing (PDF, Postscript, or the like) by demand print engine 140, wherein the consolidated documents are preferably stored within document storage 122 prior to delivery to and management by demand print engine 140, as more fully described below. Preferably, the consolidated document is devoid of any extraneous, inapplicable, and/or other trivial information not originally requested by the customer via the transaction data specifics or defined by the business rules, thereby providing a customized document.

Demand print engine 140 preferably manages the production flow of documents delivered from document storage 122 of dynamic document generator and assembler 120. Preferably, demand print engine 140 groups documents into logical production lots, and distributes the documents to digital printers at remote or local geographic locations 142 and 144, or, alternatively, distributes the documents via electronic mail 146 to the customer. Additionally, and as more fully described below, print and delivery feedback or confirmation 148 is preferably relayed to transaction database 40 via demand print engine 140. Should production problems occur, demand print engine 140 provides a mechanism for routing the documents to other printers or locations.

Preferably, all customized documents are scanned prior to delivery to a common carrier (USPS, UPS, FEDEX, AIRBORNE, DHL, etc.) so that transaction database 40 can be updated via feedback 148 to reflect delivery confirmation and/or completion of orders. Additionally, when available, scanned shipping/delivery data provided by the common carriers is inserted into transaction database 40 to monitor the shipment and delivery of each transaction to its final destination. As such, the customer of the completed document(s) enjoys the benefits of fast and reliable fulfillment of their request, and of a highly personalized package of information tailored to its/his/her needs for subsequent expeditious and convenient distribution of same to the customer's consumers.

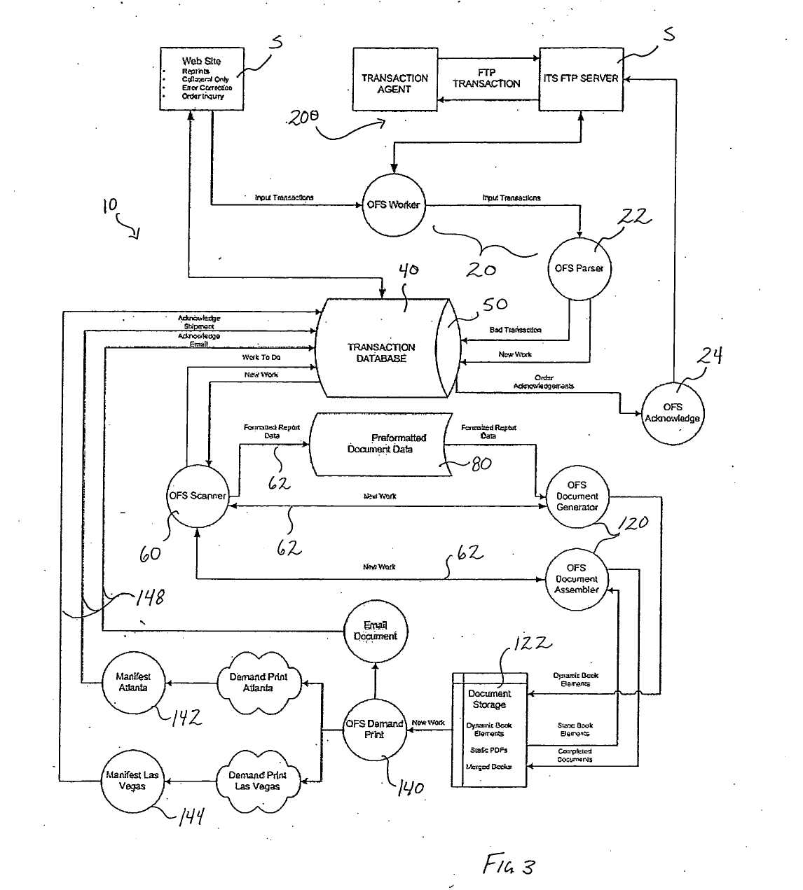

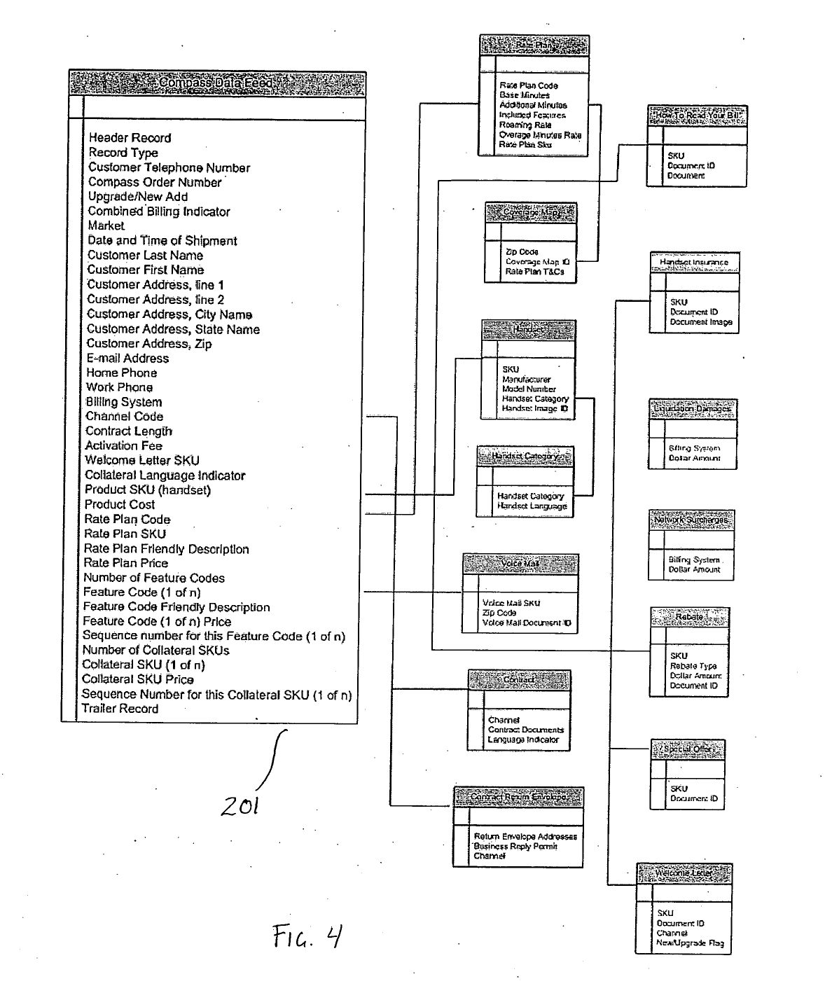

Referring now more specifically to FIGS. 3-4, illustrated therein is an exemplary application of system and method 10 to a wireless communications transaction 200, wherein system and method 10, as applied to transaction 200, is implemented in accord with the description detailed above and illustrated in FIGS. 1-2 with the addition of exemplary specifics and elements hereinafter referenced. Specifically, the transaction data originating from the order processing system of wireless telecommunications company 202 is forwarded to transaction scanning agent 20 via sources S. As best illustrated in FIG. 4, transaction data 201 preferably includes fields such as customer name, customer address, customer rate plan code, and customer feature codes, coverage maps, phone insurance information, rebate and special offer information, contract information, and the like. Transaction data 201 is preferably utilized by transaction scanning agent 60 and business rules engine 80 to assist in extracting relevant information from the look-up data and content library documents of content database 100, thereby facilitating final document compilation and assembly, as more fully described below. Preferably, transaction data 201 is accumulated several times per day and transmitted as batch files to a printing/publishing company utilizing the present system and method 10 to fulfill document publishing orders.

To facilitate proper selection and extraction of relevant information from a complete content database of information for accurate assembly and incorporation of same into a final customized document, rate plan look-up data is preferably made available by company 202 and subsequently uploaded into content database 100. The rate plan look-up data preferably provides a link between the customer rate plan code detailed in the initial transaction data 201, and further details information about the specific data components (i.e., number of minutes, standard feature codes, coverage map code, etc.) that represent all of the key elements in a typical rate plan. As such, relevant information specific to a customer's rate plan code may be extracted from the general rate plan look-up data, thereby excluding the incorporation of extraneous or inapplicable rate plan information in the final customized document. Preferably, updated rate plan look-up data is periodically (i.e., daily, weekly, or monthly) uploaded or transferred from company 202 into content database 100 of the printer/publishing company, thereby maintaining accuracy of all associated rate plan data.

Similar to the rate plan look-up data above, feature code look-up data is also preferably made available by company 202 and subsequently uploaded into content database 100. Feature code look-up data preferably links the feature codes received in the initial transaction data 201 with a feature code description and price detailed in the feature code look-up data. As such, relevant information specific to a customer's feature code may be extracted from the general feature code look-up data, thereby excluding the incorporation of extraneous or inapplicable feature code information in the final customized document. Preferably, updated feature code look-up data is periodically (i.e., daily, weekly, or monthly) uploaded or transferred from company 202 into content database 100 of the printer/publishing company, thereby maintaining accuracy of all associated feature code data.

Preferably, static content or information, such as terms and conditions, welcome letters, and/or wireless/cellular telephone insurance plans, commonly provided in printed or hardcopy form by company 202, is now preferably provided by company 202 in electronic format for subsequent forwarding or uploading of same into content database 100. As such, business rules engine 80 may selectively extract such static content and data from content database 100, thereby ensuring that the correct or applicable static content/information is formatted to match the transaction data specifics and business rules of a specific wireless telecommunications transaction 200. Preferably, the static content library documents of content database 100 include welcome letter contents, plan summary pages and layout (i.e., customer specifics, rate plan data, feature data, and the like), contract content and layout, business return envelope, general terms and conditions, rate plan specific terms and conditions, rebate forms, special offers, voicemail instructions, phone insurance information, coverage map based upon the specific rate plan, and coverage map code to identify the appropriate coverage map. Still other information may include phone operating instructions, warranties, liabilities, technical assistance, trouble-shooting information, phone accessories, plan upgrade/downgrade information, liquidation damages information, billing information, network surcharge information, roaming fees, and the like.

Preferably, and as described above, once business rules engine 80 has assembled the complete set of content information for a transaction, the data set is preferably transferred to dynamic document generator and assembler 120 for subsequent combination of same into a consolidated document optimized for electronic delivery or printing by demand print engine 140.

It should be recognized that the present system and method 10 may be utilized by a variety of industries requiring the publication of customized documents and information, wherein such industries may include, without limitation, banking and financing industries, automotive industries, utility companies, advertising companies, manufacturing companies, travel agencies, hotel industries, restaurant industries, academic institutions, and the like.

It should further be recognized that any process descriptions or blocks in FIGS. 1-4 should be understood as representing modules, segments, or portions of software code which include one or more executable instructions for implementing specific logical functions or steps in the process or system and method 10, and alternate implementations are included within the scope of the present invention in which functions may be executed out of order from that shown or discussed, including substantially concurrently or in reverse order, depending on the functionality involved, as would be understood by those reasonably skilled in the art of the present invention.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A method of publishing, said method comprising the steps of:
a. receiving a request for information, wherein said request for information is based upon an entity's transaction data, the entity selected from the group consisting of a company, a corporation, and a person;
b. comparing said request for information against a set of the entity's business rules that define the type and parameter of information needed to fulfill said request for information;
c. selecting and extracting information from a content database of variable information based upon said business rules to fulfill said request for information; and,
d. preparing the information for assembly into a final document of a selected medium for delivery to the entity for subsequent supply of same to a receiving party, the receiving party selected from the group consisting of the entity's customers, targeted consumers, and combinations thereof.

2. The method of claim 1, wherein said transaction data is selected from the group consisting of the entity's name, the entity's address, the receiving party's name, selected delivery addresses, data utilized to extract or derive specific information and content to be assembled into the final document, costumer demographics, order detail information, type of products or services purchased, product or service details, contractual duties and obligations between the receiving party and the entity, product operations manuals and instructions, product or service warranties, entity contact information, and combinations thereof.

3. The method of claim 1, wherein said transaction data is received by a transaction insertion agent.

4. The method of claim 3, wherein said transaction data is delivered to said transaction insertion agent from a source selected from the group consisting of, batch data files as delivered through file transfer protocol servers associated with a company's product or service order call centers, web-enabled interactive ordering systems as delivered by hypertext transmission protocol secure via web browsers of a global networking system, and combinations thereof.

5. The method of claim 4, further comprising the step of a′: performing, via said transaction insertion agent, analysis and error-checking functions on said transaction data.

6. The method of claim 5, further comprising the step of a″: performing, via said transaction insertion agent, parsing or dividing of said transaction data into functional data components for validating same against a specification or parameter that defines accurate, complete and error-free data entries, thereby yielding error-free transaction data.

7. The method of claim 6, further comprising the step of a′″:, inserting said error-free transaction data into a transaction database.

8. The method of claim 6, further comprising the step of a′″: routing said transaction data having erroneous or invalid data into an error transaction file for returning same to said source for correction and resubmission of same.

9. The method of claim 6, further comprising the step of a′″: confirming all orders or submissions of transaction data by transmitting confirmation of receipt of same said sources.

10. The method of claim 7, further comprising the step of b′: issuing transaction status reports to a transaction scanning agent, thereby enabling said transaction scanning agent to constantly monitor the status of new, pending and old requests for information.

11. The method of claim 10, wherein said transaction scanning agent verifies that said request for information progresses through said method on schedule for yielding the final document.

12. The method of claim 11, wherein said step b. of comparing said request for information against a set of business rules is systematically processed by said transaction scanning agent.

13. The method of claim 12, wherein said set of business rules is derived from said request for information.

14. The method of claim 13, wherein said set of business rules comprises rules selected from the group consisting of prioritization of workflow, where the final document is to be printed, instructions for formatting informational content of the final document, and combinations thereof.

15. The method of claim 14, further comprising the step of b′″: said transaction scanning agent dispatching said requests for information to a business rules engine for subsequent processing by same.

16. The method of claim 15, wherein said step c. of selecting and extracting information is implemented via said business rules engine, wherein said business rules engine utilizes said error-free transaction data of said transaction database and said set of business rule to locate, identify and selectively extract information from a content database.

16. The method of claim 15, wherein said content database comprises a plurality of look-up data and library document content ranging from general to specific information for creating the final document.

17. The method of claim 16, wherein said business rules engine sets aside for error handling said request for information if a complete set of content cannot be assembled for the final document.

18. The method of claim 17, further comprising step d.: transmitting the information extracted from said content database to a dynamic document generator and assembler for appropriate assembly of the final document.

19. The method of claim 17, further comprising step e.: combining, via said dynamic document generator and assembler, the information extracted from said content database into the final document for delivery to a demand print engine for producing the final document in the selected medium, the selected medium selected from the group consisting of electronic delivery, hard-copy prints, and combinations thereof.

20. The method of claim 19, further comprising step f.: utilizing said demand print to group final documents into logical production lots for distributing the final documents to digital printers at remote or local geographic locations or, for distributing the documents via electronic mail to the entity or receiving party.

21. The method of claim 19, further comprising step g.: relaying print and delivery feedback and confirmation to said transaction database via said demand print engine.

22. The method of claim 19, further comprising step h.: scanning a tracking number or bar code of the final document prior to and after delivery of the final document to the entity so that said transaction database can be updated via feedback to reflect delivery confirmation and/or completion of said request for information.

23. A software-implemented system of publishing, comprising:
a set of customer business rules utilized to evaluate a customer's transactional request for information against variable information comprised within an information content database so as to facilitate accurate selection and extraction of requested transactional-related data and library documents therefrom for incorporation into at least one consolidated document to fulfill said customer's transactional request for information, thereby preventing the incorporation of extraneous and inapplicable information into said document.

24. A software-implemented system of publishing, comprising:
a means for receiving a transactional request for information, said transactional request for information defining the specifics and parameters of informational content for creating a customized document;
a set of business rules derived from said transactional request for information, said set of business rules selected from the group consisting of prioritization of workflow, printing destination of the customized document, instructions for formatting informational content of the customized document, and combinations thereof; and,
a business rules engine for evaluating said transactional request for information and said a set of business rules against a variety of general to specific information stored within a content database, wherein said business rules engine locates, identifies and selectively extracts relevant information from said content database for incorporating and assembling same into the customized document, thereby completing said transactional request for information.
